(19) United States
(12) Patent Application Publication
(10) Pub. No.: US 2023/0171048 A1
(43) Pub. Date: Jun. 1, 2023

(54) TERMINAL

(71) Applicant: NTT DOCOMO, INC., Tokyo (JP)

(72) Inventors: Hiroki Harada, Tokyo (JP); Naoya Shibaike, Tokyo (JP); Satoshi Nagata, Tokyo (JP); Jing Wang, Beijing (CN); Xiaolin Hou, Beijing (CN)

(73) Assignee: NTT DOCOMO, INC., Tokyo (JP)

(21) Appl. No.: 17/921,767

(22) PCT Filed: Apr. 28, 2020
(86) PCT No.: PCT/JP2020/018190

§ 371 Date: Oct. 27, 2022

(51) Int. Cl. H04L 5/00; H04W 72/12; H04L 1/1812

(52) U.S. Cl. CPC H04L 5/001; H04W 72/12; H04L 1/1812

(57) ABSTRACT

A terminal receives, from a network, first control information and second control information, the first control information being intended for a group including a plurality of component carriers, the second control information being intended for each of the plurality of component carriers. The terminal selects either the first control information or the second control information and controls the plurality of component carriers on the basis of the first control information or the second control information thus selected.

### TECHNICAL FIELD

The present disclosure relates to a terminal that makes radio communication, and more particularly, to a terminal that makes radio communication on a plurality of component carriers.

### BACKGROUND ART

The 3rd Generation Partnership Project (3GPP) has developed the specification of 5th generation mobile communication system (5G, also referred to as New Radio (NR) or Next Generation (NG)), and the specification of the next generation referred to as Beyond 5G, 5G Evolution or 6G is also under development.

Release 15 and Release 16 (NR) of 3GPP specify the operation in a plurality of frequency ranges, specifically, bands including FR1 (410 MHz to 7.125 GHz) and FR2 (24.25 GHz to 52.6 GHz).

Further, NR that supports up to 71 GHz over 52.6 GHz is also under study (Non Patent Literature 1). Furthermore, Beyond 5G, 5G Evolution, or 6G (Release 18 or later) aims to support a frequency band over 71 GHz.

When the available frequency band is expanded in this way, it is expected that more component carriers (CC) will be configured.

For carrier aggregation (CA), the number of configurable CCs is specified. For example, Release 15 and Release 16 of 3GPP specify the maximum number of configurable CCs for a terminal (User Equipment, UE) of 16 for downlink (DL) and 16 for uplink (UL).

Further, for NR, it is specified that cross carrier scheduling with a Carrier Indicator Field (CIF) allows a Physical Downlink Control Channel (PDCCH) of a serving cell to schedule resources on another serving cell (Non Patent Literature 2).

Further, for NR, it is specified that a Hybrid Automatic repeat request (HARQ) entity is configured for each serving cell (Non Patent Literature 3).

### CITATION LIST

### Non Patent Literature

Non Patent Literature 1: “New WID on Extending current NR operation to 71 GHz”, RP-193229, 3GPP TSG RAN Meeting #86, 3GPP, December 2019
Non Patent Literature 2: 3GPP TS 38.300 V16.1.0, 3rd Generation Partnership Project; Technical Specification Group Radio Access Network; NR; Medium Access Control (MAC) protocol specification (Release 16), 3GPP, March 2020
Non Patent Literature 3: 3GPP TS 38.321 V16.1.0, 3rd Generation Partnership Project; Technical Specification Group Radio Access Network; NR; Medium Access Control (MAC) protocol specification (Release 16), 3GPP, March 2020

### SUMMARY OF INVENTION

Taking into consideration cross carrier scheduling as described above, normal control information intended for a specific CC (for example, control information of the radio resource control (RRC) layer) and, control information intended for a plurality of CCs across cells as in cross carrier scheduling may exist.

However, this may prevent the terminal (UE) from appropriately determining which control information should be applied to a CC. Further, such a problem also applies to an HARQ entity.

The following disclosure has been made in view of such circumstances, and it is therefore an object of the disclosure to provide a terminal that appropriately operates even in a case such as cross carrier scheduling where a plurality of CCs across cells are controlled.

Provided according to one aspect of the present disclosure is a terminal (UE 200) including a receiver (control signal and reference signal processor 240) that receives, from a network, first control information and second control information, the first control information being intended for a group including a plurality of component carriers, the second control information being intended for each of the plurality of component carriers, and a controller (controller 270) that selects either the first control information or the second control information and controls the plurality of component carriers on the basis of the first control information or the second control information thus selected.

Provided according to one aspect of the present disclosure is a terminal (UE 200) including a controller (controller 270) that configures an automatic repeat request entity, the controller configuring the entity to be associated with a group including a plurality of component carriers and the entity to be associated with a component carrier belonging to the group.

### BRIEF DESCRIPTION OF DRAWINGS

FIG. 1 is an overall schematic structure diagram of a radio communication system 10.

FIG. 2 is a diagram illustrating frequency ranges used in the radio communication system 10.

FIG. 3 is a diagram illustrating a structure example of a radio frame, subframe, and slot used in the radio communication system 10.

FIG. 4 is a functional block structure diagram of a UE 200.

FIG. 5 is a diagram illustrating an example of CORESET allocation to a frequency domain and time domain.

FIG. 6 is a diagram illustrating a configuration example of a plurality of CCs (including a group) and an HARQ entity according to a first operation example.

FIG. 7 is a diagram illustrating a configuration example (No. 1) of a plurality of CCs and a CORESET (including a PDSCH) according to the first operation example.

FIG. 8 is a diagram illustrating a configuration example (No. 2) of a plurality of CCs and a CORESET (including a PDSCH) according to the first operation example.

FIG. 9 is a diagram illustrating a configuration example (No. 1) of a plurality of CCs and a CORESET (including a PDSCH) according to a second operation example.

FIG. 10 is a diagram illustrating a configuration example (No. 2) of a plurality of CCs and a CORESET (including a PDSCH) according to the second operation example.

FIG. 11 is a diagram illustrating an example of a hardware configuration of the UE 200.

### DESCRIPTION OF EMBODIMENTS

Embodiments will be described below with reference to the drawings. Note that the same functions and configurations are denoted by the same or similar reference numerals, and no description will be given of such functions and configurations as appropriate.

### (1) Overall Schematic Structure of Radio Communication System

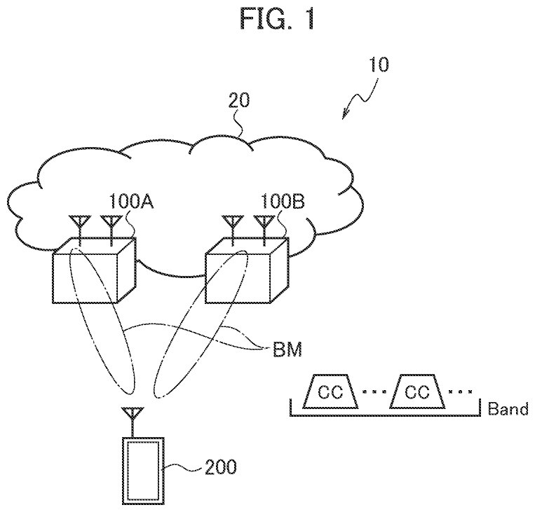

FIG. 1 is an overall schematic structure diagram of a radio communication system 10 according to the present embodiment. The radio communication system 10 is a radio communication system based on 5G New Radio (NR), and includes a Next Generation-Radio Access Network 20 (hereinafter, referred to as a NG-RAN 20) and a terminal 200 (hereinafter, referred to as a UE 200).

Note that the radio communication system 10 may be a radio communication system based on an architecture called Beyond 5G, 5G Evolution, or 6G.

The NG-RAN 20 includes a radio base station 100A (hereinafter, referred to as a gNB 100A) and a radio base station 100B (hereinafter, referred to as a gNB 100B). Note that a specific structure of the radio communication system 10 including the numbers of gNBs and UEs is not limited to the example illustrated in FIG. 1.

The NG-RAN 20 practically includes a plurality of NG-RAN Nodes, specifically, gNBs (or ng-eNBs) and is connected to a core network (5GC, not illustrated) based on 5G. Note that the NG-RAN 20 and the 5GC may be simply referred to as a “network”.

The gNB 100A and the gNB 100B are radio base stations based on 5G and make radio communication with the UE200 on the basis of 5G. The gNB 100A, the gNB 100B, and the UE200 are adaptable to Massive MIMO (Multiple-Input Multiple-Output) that generates a beam BM with higher directivity through control over radio signals transmitted from a plurality of antenna elements, carrier aggregation (CA) in which a plurality of component carriers (CCs) are aggregated and then used, dual connectivity (DC) in which a UE communicates with two NG-RAN Nodes at the same time, and the like.

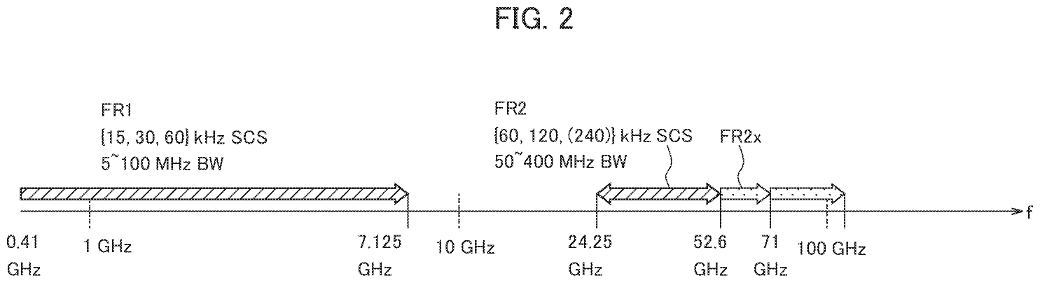

Further, the radio communication system 10 is adapted to a plurality of frequency ranges (FRs). FIG. 2 illustrates frequency ranges used in the radio communication system 10.

As illustrated in FIG. 2, the radio communication system 10 is adapted to FR1 and FR2. The respective frequency bands of the FRs are as follows.
FR1: 410 MHz to 7.125 GHz
FR2: 24.25 GHz to 52.6 GHz

FR1 may employ a Sub-Carrier Spacing (SCS) of 15, 30 or 60 kHz and a bandwidth (BW) of 5 to 100 MHz. FR2 is higher in frequency than FR1 and may employ a SCS of 60 or 120 kHz (may include 240 kHz) and a bandwidth (BW) of 50 to 400 MHz.

Note that SCS may be interpreted as numerology. The numerology is defined in 3GPP TS38.300 and corresponds to one sub-carrier spacing in the frequency domain.

The radio communication system 10 is further adapted to a frequency band higher than the frequency band of FR2. Specifically, the radio communication system 10 is adapted to a frequency band up to 71 GHz over 52.6 GHz. Such a high frequency band may be referred to as “FR2x” for convenience.

In order to handle such a situation, Cyclic Prefix-Orthogonal Frequency Division Multiplexing (CP-OFDM)/Discrete Fourier Transform-Spread (DFT-S-OFDM) having a larger Sub-Carrier Spacing (SCS) may be applied to a case where a band over 52.6 GHz is used.

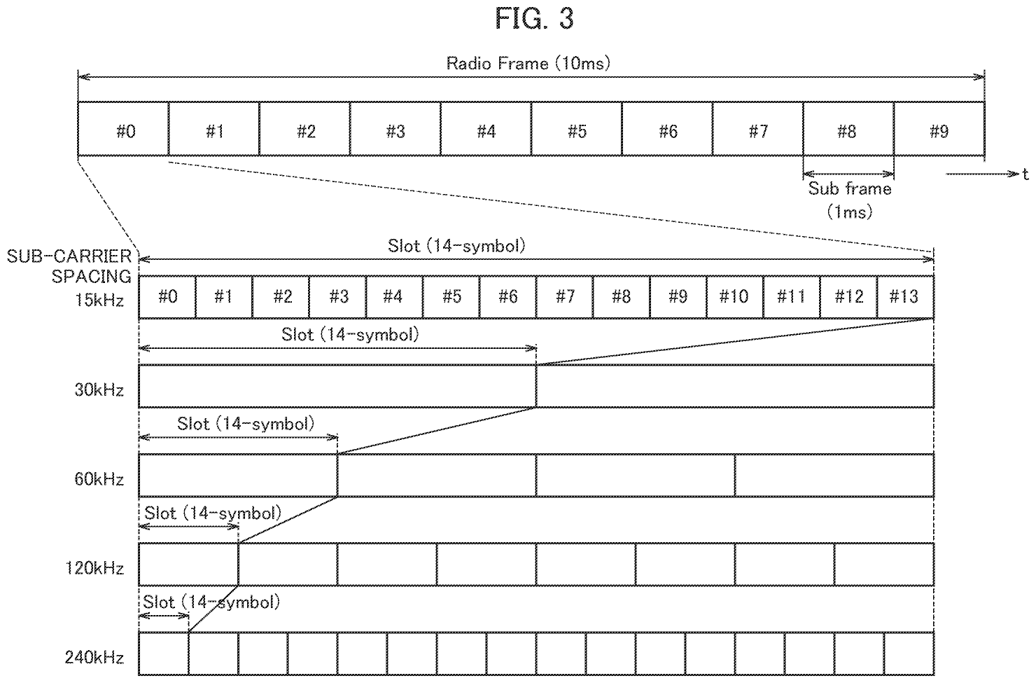

FIG. 3 illustrates a structure example of a radio frame, subframe, and slot used in the radio communication system 10.

As illustrated in FIG. 3, one slot includes 14 symbols, and the larger (wider) the SCS, the shorter a symbol duration (and a slot duration). The SCS is not limited to the spacings (frequencies) illustrated in FIG. 3. For example, 480 kHz, 960 kHz, or the like may be used.

Further, the number of symbols per slot need not necessarily be 14 (alternatively, for example, 28 or 56). Further, the number of slots per subframe may vary in a manner that depends on the SCS.

Note that the time direction (t) illustrated in FIG. 3 may be referred to as a time domain, a symbol duration, a symbol time, or the like. Further, the frequency direction may be referred to as a frequency domain, a resource block, a subcarrier, a bandwidth part (BWP), or the like.

The BWP may be interpreted as a contiguous set of Physical Resource Blocks (PRBs) selected from a contiguous subset of common resource blocks for a given numerology on a given carrier.

BWP information (bandwidth, frequency position, sub-carrier spacing (SCS)) to be used by the UE 200 for radio communication can be configured for the UE 200 through higher layer (for example, radio resource control (RRC) layer) signaling. A different BWP may be configured for each UE 200 (terminal). The BWP may be changed through higher layer signaling or lower layer signaling, specifically, physical layer (L1) signaling (such as Downlink Control Information (DCI) to be described later).

In the radio communication system 10, a number of CCs for CA may be supported to achieve higher throughput. For example, when the maximum CC bandwidth is 400 MHz, up to 32 CCs can be arranged in FR2x, specifically, the frequency band of 57 GHz to 71 GHz. Note that the maximum number of CCs to be configured may exceed 32, or may be equal to or less than 32.

Further, the DCI may contain the following information.

(i) Uplink (UL) resource allocation (persistent or non-persistent)

(ii) Description of downlink (DL) data transmitted to UE200

The DCI may be a set of pieces of information that can schedule a downlink data channel (for example, a Physical Downlink Shared Channel (PDSCH)) or an uplink data channel (for example, a Physical Uplink Shared Channel PUSCH)). Such DCI may be particularly referred to as scheduling DCI.

The DCI can be transmitted on a downlink control channel, specifically, a Physical Downlink Control Channel (PDCCH). Further, a DL radio resource used for PDCCH transmission can be specified by control resource sets (CORESET). That is, the CORESET may be interpreted as a set of physical resources (specifically, a specific area on a DL resource grid) and parameters used for carrying a PDCCH (including DCI).

The UE 200 can assume, on the basis of the timing and period specified by Search Space, specifically, Common Search Space (CSS), the specific area to which the CORESET is allocated.

Further, in the radio communication system 10, control using Transmission Configuration Indication (TCI) is executed. The TCI may be defined by a higher layer parameter (for example, a tci-PresentInDCI field). The tci-PresentInDCI may indicate whether the TCI field is present in a DL-related DCI. When the TCI field is not present, the UE 200 may consider that the TCI is not present or is disabled.

For cross carrier scheduling, the network can make the TCI field enabled for control resource sets (CORESET) used for cross carrier scheduling in a scheduling cell. The TCI provides information on, for example, Quasi Co-Location (QCL) of antenna ports for Physical Downlink Control Channel (PDCCH).

Cross carrier scheduling is specified in chapter 10.8 of 3GPP TS38.300, and the like. Cross carrier scheduling with the Carrier Indicator Field (CIF) allows a PDCCH of the serving cell to schedule resources of another serving cell. Cross carrier scheduling may be simply interpreted as scheduling executed across a plurality of CCs.

QCL may be is interpreted as a situation where two antenna ports are quasi co-located if properties of the channel over which a symbol on one antenna port is conveyed can be inferred from the channel over which a symbol on the other antenna port is conveyed.

### (2) Functional Block Structure of Radio Communication System

Next, a functional block structure of the radio communication system 10 will be described. Specifically, a functional block structure of the UE 200 will be described.

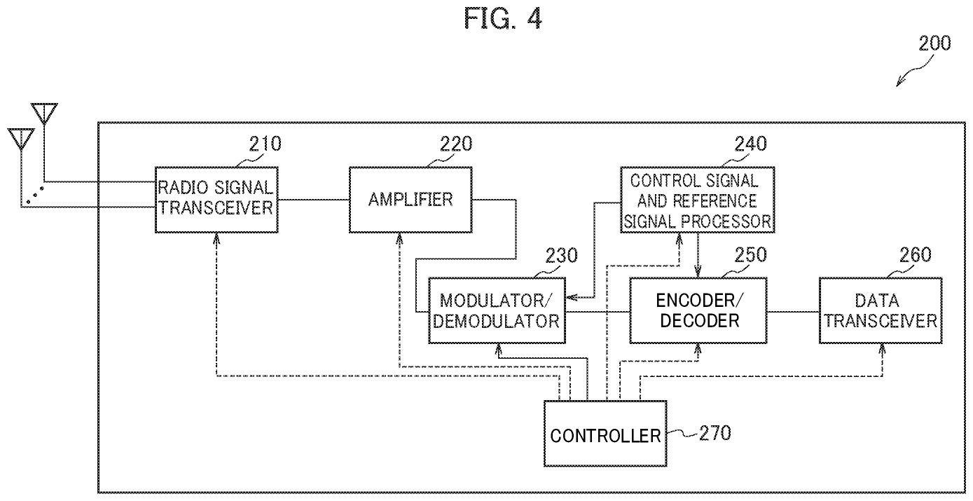

FIG. 4 is a functional block structure diagram of the UE 200. As illustrated in FIG. 4, the UE 200 includes a radio signal transceiver 210, an amplifier 220, a modulator/demodulator 230, a control signal and reference signal processor 240, an encoder/decoder 250, a data transceiver 260, and a controller 270.

The radio signal transceiver 210 transmits or receives a radio signal based on NR. The radio signal transceiver 210 is adapted to Massive MIMO, CA in which a plurality of component carriers (CC) are aggregated and then used, DC in which a UE communicates with two NG-RAN Nodes at the same time, and the like.

According to the present embodiment, the radio signal transceiver 210 receives a downlink control channel from the network (the gNB 100A or the gNB 100B, the same applies below).

Specifically, the radio signal transceiver 210 receives a PDCCH. The PDCCH may be transmitted across a plurality of CCs as will be described later.

The PDCCH is transmitted in control resource sets (CORESET) as described above. According to the present embodiment, the CORESET may also be transmitted across a plurality of CCs, that is, the CORESET may be divided into blocks and then transmitted on the plurality of CCs.

Specifically, the CORESET may be divided into at least two blocks, specifically a first block and a second block.

That is, the radio signal transceiver 210 can receive the CORESET including the first block and the second block from the network. Note that the CORESET may be divided into three or more blocks and then transmitted on two or more CCs.

The amplifier 220 is configured by a Power Amplifier (PA)/Low Noise Amplifier (LNA), and the like. The amplifier 220 amplifies a signal output from the modulator/demodulator 230 to a predetermined power level. Further, the amplifier 220 amplifies an RF signal output from the radio signal transceiver 210.

The modulator/demodulator 230 is responsible for data modulation/demodulation, transmission power configuration, resource block allocation, and the like for each predetermined communication destination (the gNB 100A or the like). Cyclic Prefix-Orthogonal Frequency Division Multiplexing (CP-OFDM)/Discrete Fourier Transform-Spread (DFT-S-OFDM) may be applied to the modulator/demodulator 230. Further, DFT-S-OFDM may be applied to not only the uplink (UL) but also the downlink (DL).

The control signal and reference signal processor 240 is responsible for processing on various control signals transmitted and received by the UE 200 and processing on various reference signals transmitted and received by the UE 200.

Specifically, the control signal and reference signal processor 240 receives various control signals transmitted from the gNB 100A on a predetermined control channel, for example, the control signal of the radio resource control (RRC) layer. Further, the control signal and reference signal processor 240 transmits various control signals to the gNB 100A on a predetermined control channel.

The control signal and reference signal processor 240 is responsible for processing using reference signals (RS) such as a Demodulation Reference Signal (DMRS) and a Phase Tracking Reference Signal (PTRS).

The DMRS is a reference signal (pilot signal) known between a terminal-specific base station and the terminal for use in estimation of a fading channel used for data demodulation. The PTRS is a terminal-specific reference signal for use in estimation of phase noise, which is a problem in high frequency bands.

Note that such reference signals may include, in addition to the DMRS and the PTRS, a Channel State Information-Reference Signal (CSI-RS), a Sounding Reference Signal (SRS), a Positioning Reference Signal (PRS) for position information, and the like.

Further, the channel includes a control channel and a data channel. The control channel includes a Physical Downlink Control Channel (PDCCH), a Physical Uplink Control Channel (PUCCH), a Random Access Channel (RACH, Downlink Control Information (DCI) including Random Access Radio Network Temporary Identifier (RA-RNTI)), a Physical Broadcast Channel (PBCH), and the like.

The data channel includes a Physical Downlink Shared Channel (PDSCH), a Physical Uplink Shared Channel (PUSCH), and the like. Data may correspond to data to be transmitted on such data channel. The data channel may also be read as a shared channel.

According to the present embodiment, the control signal and reference signal processor 240 is capable of receiving a plurality of types of control information. Specifically, the control signal and reference signal processor 240 is capable of receiving two types of control information (referred to as first control information and second control information) from the network.

The first control information is intended for a group including a plurality of component carriers (a plurality of CCs). The second control information is intended for each of the plurality of CCs. According to the present embodiment, the control signal and reference signal processor 240 serves as a receiver.

A layer used for transmitting the first control information and the second control information to the UE 200 is not limited to a specific layer, and the RRC may be used typically. Therefore, the first control information and the second control information may be referred to as an RRC set.

The first control information and the second control information may be defined as individual RRC messages (information elements), or alternatively, may be defined as new fields belonging to the existing RRC message.

The encoder/decoder 250 is responsible for data division/concatenation, channel coding/decoding, and the like for each predetermined communication destination (gNB 100A or the like).

Specifically, the encoder/decoder 250 divides the data output from data transceiver 260 into pieces of data each having a predetermined size, and executes channel coding on the data thus divided. Further, the encoder/decoder 250 decodes the data output from the modulator/demodulator 230 and concatenates the data thus decoded.

The data transceiver 260 is responsible for transmission and reception of a Protocol Data Unit (PDU) and a Service Data Unit (SDU). Specifically, the data transceiver 260 concatenates/divides the PDU/SDU in a plurality of layers (medium access control (MAC) layer, radio link control (RLC) layer, packet data convergence protocol (PDCP) layer, and the like). Further, the data transceiver 260 executes data error correction and retransmission control on the basis of a Hybrid automatic repeat request (HARQ).

Further, the data transceiver 260 is capable of transmitting and receiving a transport block (TB) that is a transport-level data unit. In particular, according to the present embodiment, the data transceiver 260 is capable of transmitting and receiving a TB across a plurality of CCs.

The controller 270 is responsible for controlling each functional block of the UE 200. In particular, according to the present embodiment, the controller 270 is capable of controlling a plurality of CCs.

As described above, according to the present embodiment, the CORESET may be transmitted across a plurality of CCs, and the TB may be transmitted across a plurality of CCs.

The controller 270 selects either the first control information or the second control information from the RRC set (the first control information and the second control information) received by the control signal and reference signal processor 240. Further, the controller 270 is capable of controlling a plurality of CCs on the basis of the first control information or second control information thus selected.

For example, when selecting the first control information intended for a group including a plurality of CCs, the controller 270 may collectively control the plurality of CCs belonging to the group on the basis of the first control information. Note that the group may include one or a plurality of CCs, and a plurality of such groups may be configured. The group may further include a sub-group.

On the other hand, when selecting the second control information intended for each of the plurality of CCs, the controller 270 may control, on an individual basis, the CCs on the basis of the second control information.

The controller 270 is capable of configuring an automatic repeat request entity. Specifically, the controller 270 is capable of controlling the data transceiver 260 to configure the HARQ entity (HARQentity).

When selecting the first control information, the controller 270 may configure an HARQentity to be associated with a group (sub-group) of a plurality of CCs.

That is, not only an HARQentity to be associated with normal single-CC scheduling, but also an HARQ entity to be associated with a group of a plurality of CCs (may be referred to as multi-CC scheduling) may be configured.

Further, with cross carrier scheduling applied, the controller 270 may schedule another component carrier on the basis of a reference component carrier (reference CC) belonging to the group.

The controller 270 may configure an HARQ entity to be associated with a group including a plurality of CCs and an HARQentity to be associated with a CC belonging to the group.

That is, for the CC belonging to the group, the HARQentity to be associated with the group and the HARQ entity to be associated with the CC may coexist.

Further, the controller 270 may assume that information on a bandwidth part (BWP) and information on a transmission configuration indication (TCI) are commonly applied to the group and each CC belonging to the group.

Specifically, the controller 270 may assume that a BWP applied to the group and a BWP applied to the CC are the same. Similarly, the controller 270 may assume that a TCI applied to the group and a TCI applied to the CC are the same.

### (3) Operation of Radio Communication System

Next, the operation of the radio communication system 10 will be described. Specifically, a description will be given of the operation of the UE 200 in a case where normal control information intended for a specific CC and control information intended for a plurality of CCs across cells such as cross carrier scheduling exist.

### (3.1) Precondition

As described above, the radio communication system 10 is adapted to the frequency band (FR2x) up to 71 GHz over 52.6 GHz. The high frequency band such as FR2x is essentially different from FR1 and FR2 in the following points.

(Channel/Radio Wave Propagation)
Expansion of available bandwidth (by approximately 13 GHz (in a case of 57 to 71 GHz unlicensed band))
Low delay spread resulting from large path-loss due to non-line of sight (NLOS)

(Device (Terminal))
Small-sized antenna element in accordance with a wavelength (large-scale (massive) antenna using the small-sized antenna element)
High directivity based on analog beamforming (narrow beam width)
Reduction in efficiency of power amplifier (increase in peak-to-average power ratio (PAPR))
Increase in phase noise (applicability of higher SCS and shorter symbol time)

Further, unless a very wide CC bandwidth is supported, the wider the available bandwidth, the higher the possibility that more CCs are configured. As described above, when the maximum CC bandwidth is 400 MHz as in FR2, up to 32 CCs can be arranged in the frequency band of 57 GHz to 71 GHz.

Carrier aggregation (CA) has a limit to the number of configurable CCs. Specifically, in Releases 15 and 16 of 3GPP, the maximum number of configurable CCs for the UE 200 is 16 for DL and 16 for UL (chapter 5.4.1 of 3GPP 38.300).

On the other hand, the configurations for the physical (L1, PHY) layer and the medium access control (MAC) layer are made for each CC. In Releases 15 and 16 of 3GPP, one DCI can schedule only one CC, and thus a number of DCIs are required to schedule a number of CCs. This may cause the capacity of PDCCH to be tight.

Further, one transport block (TB) can be transmitted on only one CC (that is, one TB cannot be mapped to a plurality of CCs), and a number of Hybrid Automatic repeat request (HARQ) Acknowledgement (ACK) bits are required for a number of CCs.

Furthermore, beam management (Transmission Configuration Indication (TCI) state) is also made for each CC. Specifically, in Release 16 of 3GPP, one MAC-CE can update/activate TCI states of a plurality of CCs, but one DCI can update the TCI state of only one CC.

Although there are such restrictions, it is assumed that channel properties of a plurality of CCs within a single wide band do not differ so much, so that operation in separate PHY and MAC layers for each CC is not always necessary or efficient.

### (3.2) Consideration

When a plurality of component carriers (CCs) are configured with consideration given to the above-described preconditions, more efficient CORESET configuration and TB scheduling are conceivable.

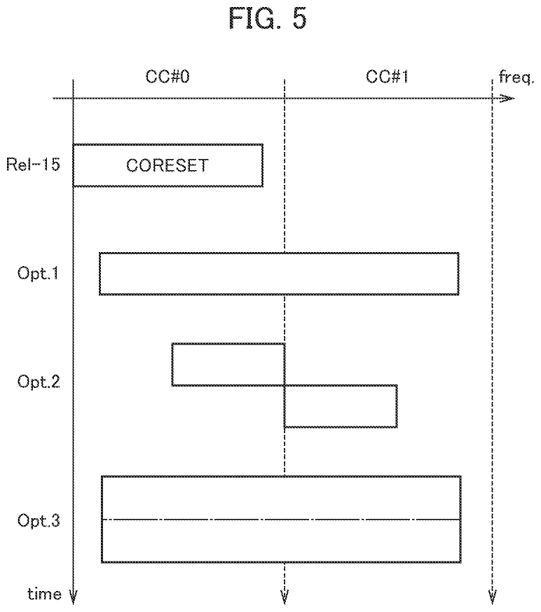

FIG. 5 illustrates an example of CORESET allocation to the frequency domain and the time domain. As illustrated in FIG. 5, the CORESET may be configured across a plurality of CCs (CC#0 and CC#1), that is, may be divided and then transmitted. Note that the number of CCs across which one CORESET is configured is not limited to two, and may be three or more. Further, the CCs may be contiguous or non-contiguous in the frequency domain.

Such CORESET allocation allows highly flexible PDCCH scheduling on a plurality of CCs (for example, transmission of one transport block (TB) on a plurality of CCs).

Further, single-TB/channel scheduling across a plurality of CCs may be supported. In this case, the scheduling may be activated or deactivated on the basis of RRC, MAC CE or DCI, and two RRC parameter sets (may be referred to as RRC sets) may be specified.

Specifically, one RRC set may be configured for normal CC scheduling, and the other RRC set may be configured for scheduling across a plurality of CCs.

In this case, the UE 200 may notify the network (gNB) of whether the UE 200 supports scheduling across a plurality of CCs. Further, guard subcarriers between CCs may be used for resource allocation (or the guard subcarriers may be rate matched with each other).

Further, a single BWP across a plurality of CCs may be supported. When such support is enabled, a Transport block size (TBS) may be determined on the basis of resource allocation across a plurality of CCs (large TBS is supported).

Such single-TB/channel scheduling can reduce, even when a number of CCs are configured, overhead due to HARQ feedback.

Further, as described above, in NR (see chapter 10.8 of 3GPP T538.300), cross carrier scheduling with the Carrier Indicator Field (CIF) allows the PDCCH of a serving cell to schedule resources of another serving cell.

Cross carrier scheduling does not apply to a PCell. The PCell may be always scheduled via its PDCCH. Further, when an SCell is configured with a PDCCH, SCell's PDSCH and PUSCH may be always scheduled by the PDCCH on this SCell.

Note that when an SCell is not configured with a PDCCH, SCell's PDSCH and PUSCH may be scheduled by a PDCCH on another serving cell. Cross carrier scheduling can be configured by CrossCarrierSchedulingConfig (see chapter 6.3.2 of 3GPP TS38.331) that is an information element (IE) of RRC.

Further, NR (see chapter 5.3, 5.4 of 3GPP TS38.321 and the like) specifies that an HARQ entity is configured for each serving cell. Specifically, a MAC entity may include an HARQ entity for each serving cell and may maintain a number of parallel HARQ processes.

### (3.3) Problem

In light of the contents of the above consideration, there are the following problems. Two types of configured RRC sets (control information), specifically, from the viewpoint of a specific CC as described above, an RRC set for scheduling for a single CC and an RRC set for a plurality of CCs may exist.

Therefore, the UE 200 cannot appropriately determine whether to apply both the RRC sets or apply only one RRC set.

Further, it is conceivable that the UE 200 cannot make an appropriate determination on the presence or absence of an HARQ entity and HARQ process for a plurality of CCs or the configuration between a CORESET and a PDSCH with consideration given to single-CC scheduling and multi-CC scheduling.

Hereinafter, an operation example of the UE 200 that can solve such problems will be described.

### (3.4) Operation Example

### (3.4.1) First Operation Example

According to the present operation example, the UE 200 can control a plurality of CCs on the basis of any one of received two types of RRC sets (the first control information and the second control information).

Specifically, for each CC, that is, from a CC's viewpoint, only one (one type) RRC set can be configured. In other words, to each CC, either single-CC scheduling (normal scheduling (may be referred to as Self-scheduling) or cross carrier scheduling) or multi-CC scheduling may be applied. Note that the concept regarding the RRC set and/or signaling may exist or need not exist.

For a CC (within the RRC set) that is subject to the single-CC scheduling, an HARQ entity may be configured for each serving cell as in the existing 3GPP specifications (chapters 5.3, 5.4 of 3GPP TS38.321).

For CCs (within the RRC set) that are subject to multi-CC scheduling, an HARQ entity may be configured for a group (or sub-group, the same applies below) intended for single-TB scheduling across the plurality of CCs. Note that a separate HARQ process may be provided for each HARQentity of each group.

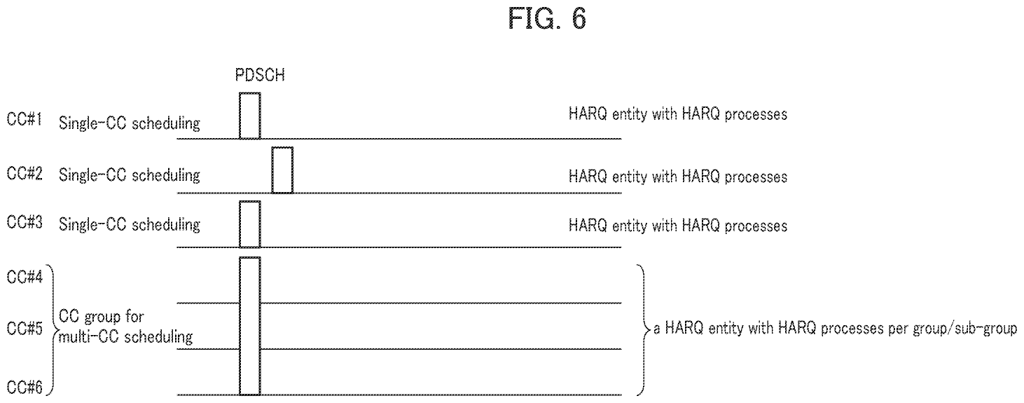

FIG. 6 illustrates a configuration example of a plurality of CCs (including a group) and an HARQ entity according to the first operation example. Specifically, in FIG. 6, CC#1, 2, 3 denote single-CC scheduling, and CC#4, 5, 6 denote multi-CC scheduling (CC group for multi-CC scheduling).

For each of CC#1, 2, 3, a corresponding HARQ entity is configured, and a corresponding HARQ process is executed. For CC#4, 5, 6, an HARQ entity common to a group to which CC#4, 5, 6 belong is configured, and one HARQ process is executed for the group.

When cross carrier scheduling is configured with another CC (may also be referred to as a Scheduling CC), the Scheduling CC (CORESET configuration for DCI detection) for CCs in the RRC set configured for single-CC scheduling is preferably one of the following.
(Alt-a): A CC in the same RRC set for single-CC scheduling
(Alt-b): A CC in the same RRC set for single-CC scheduling, a specific CC for multi-CC scheduling (for example, a reference CC for the group)
(Alt-c): Any CC in any RRC set (different from the reference CC)

Note that, to the specific CC (Alt-b), only CORESET for single-CC scheduling, only CORESET for multi-CC scheduling, or both CORESETs for single-CC scheduling and multi-CC scheduling may be allocated. When both the CORESETs are allocated, a CORESET ID may be specified together with a scheduling cell ID by the RRC.

The two CORESETs need not or may overlap one another in the time domain and the frequency domain. Note that a PCell and a Primary SCell (PSCell) need not be permitted by a SCell to enable cross carrier scheduling.

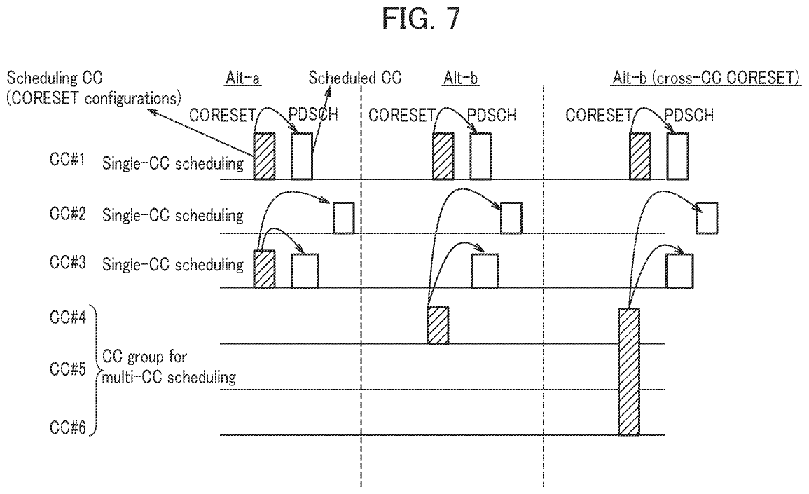

FIG. 7 illustrates a configuration example (No. 1) of a plurality of CCs and a CORESET (including a PDSCH) according to the first operation example. Specifically, FIG. 7 illustrates a state of a plurality of CCs configured on the basis of single-CC scheduling in accordance with the above-described (Alt-a) or (Alt-b).

As described above, a CORESET configuration for DCI detection is allocated to a Scheduling CC so as to allow a CC on which a PDSCH is transmitted to be identified. The CC may be referred to as a Scheduled CC in contrast with the Scheduling CC.

In (Alt-a) and (Alt-b), for single-CC scheduling, a CC in the same RRC set serve as the Scheduling CC. Further, in (Alt-b), for multi-CC scheduling, a specific CC may serve as the Scheduling CC. In this case, a CORESET may be configured across the plurality of CCs (CC#4, 5, 6) (may be referred to as a cross-CC CORESET). See also the example illustrated in FIG. 5 for cross-CC CORESET.

Although not illustrated, a plurality of CORESETs may be allocated to a CC (Scheduling CC) for single-CC scheduling and/or multi-CC scheduling.

Further, it is desirable that the Scheduling CC (CORESET configuration for DCI detection) for CCs in the RRC set for multi-CC scheduling be one of the following.
(Alt-1): A predefined specific CC in the same RRC set such as PCell/PSCell/PUCCH Cell
(Alt-2): A predefined specific CC (not necessarily in the same RRC set) such as PCell/PSCell/PUCCH Cell
(Alt-3): A configured DL reference CC in the same RRC set
(Alt-4): A configured DL reference CC (not necessarily in the same RRC set)
(Alt-5): A CC on which a cross-CC CORESET is transmitted, the CC being configured in a higher layer
(Alt-6): Any CC in any RRC set (different from a reference CC), the CC being configured in a higher layer
(Alt-7): A plurality of CCs corresponding to any combination of Alt-1 to Alt-6 (that increases complexity)

Note that, on the predefined specific CC or the DL reference CC, only a CORESET for single-CC scheduling, only a CORESET for multi-CC scheduling, or both the CORESET for single-CC scheduling and the CORESET for multi-CC scheduling may be transmitted. When both the CORESETs are transmitted, a CORESET ID may be specified together with a scheduling cell ID by the RRC.

The two CORESETs need not or may overlap one another in the time domain and the frequency domain.

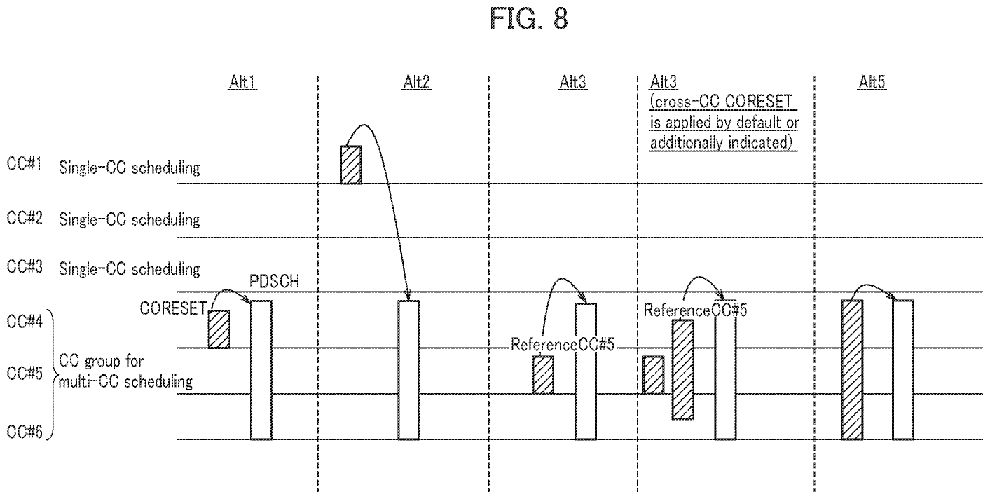

FIG. 8 illustrates a configuration example (No. 2) of a plurality of CCs and a CORESET (including a PDSCH) according to the first operation example. Specifically, FIG. 8 illustrates a state of a plurality of CCs configured on the basis of multi-CC scheduling in accordance with the above-described (Alt-1) to (Alt-3) and (Alt-5).

In (Alt-1) and (Alt-2), the predefined specific CC serves as the Scheduling CC. In (Alt-3), the configured DL reference CC in the same RRC set serves as the Scheduling CC. FIG. 8 illustrates an example where CC#5 is selected as the DL reference CC.

Also in this case, a cross-CC CORESET as described above may be configured. Further, a plurality of CORESETs may be allocated to the Scheduling CC.

In (Alt-5), a CC configured in a higher layer and on which the cross-CC CORESET is transmitted serves as the Scheduling CC.

### (3.4.2) Second Operation Example

According to the present operation example, the UE 200 can configure an HARQ entity to be associated with a group including a plurality of CCs and an HARQentity to be associated with a CC belonging to the group.

Specifically, as in the first operation example, both single-CC scheduling and multi-CC scheduling can be configured. Note that two types of RRC sets may contain a CC index.

According to the present operation example, two types of HARQ entities can be configured for a CC to which such two types of scheduling modes are applicable. Specifically, an HARQentity for single-CC scheduling and an HARQ entity for multi-CC scheduling (group for single-TB scheduling across the plurality of CCs) can be configured. It is desirable that a separate HARQ process be provided for each HARQentity and can be distinguished by the UE 200.

For a CC to which such two types of scheduling modes are applicable, it is desirable that BWP configurations and TCI states for single-CC scheduling and multi-CC scheduling be the same.

For example, when dynamic BWP switching (BWP switch) across a plurality of CCs via DCI is supported, the BWP switch may also be applied to single-CC scheduling.

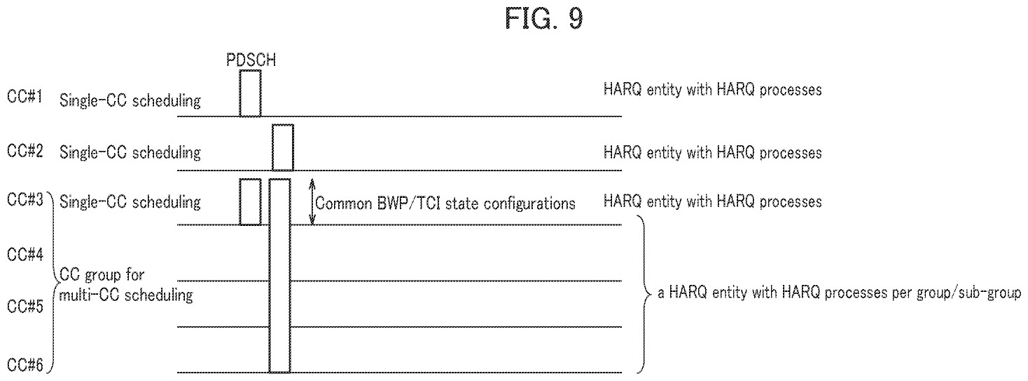

FIG. 9 illustrates a configuration example (No. 1) of a plurality of CCs and a CORESET (including a PDSCH) according to the second operation example. As illustrated in FIG. 9, an HARQ entity for each CC is configured, and an HARQ entity to be associated with a group including a plurality of CCs (CC#3, 4, 5, 6) is configured.

Both single-CC scheduling and multi-CC scheduling are applied to CC#3. As described above, it is preferable that a common BWP configuration and TCI state be applied to CC#3.

Further, according to the present operation example, the following options may be configured.
(Option 1): Scheduling CC configurations for single-CC scheduling and multi-CC scheduling may be the same as in first operation example.

This may mean that a separate Scheduling CC (and CORESET configuration) is configured for each scheduling mode.

Such different Scheduling CC (CORESET) configurations allow the UE 200 to easily identify the scheduling mode of each PDSCH for HARQ entity and HARQ process configurations.

Further, when the same Scheduling CC (CORESET) is configured for both the scheduling modes, the UE 200 can distinguish the respective scheduling modes and HARQ entities of PDSCHs on the basis of the DCI format or the contents of DCI.
(Option 2): For CCs to which both the scheduling modes are applied, a common Scheduling CC (and shared CORESET configuration) may be configured for both the scheduling modes.

The UE 200 can distinguish the respective scheduling modes and HARQ entities of PDSCHs on the basis of the DCI format or the contents of DCI.

In Option 1 or Option 2, when the same Scheduling CC is configured for both the scheduling modes, DCI detection may be made at the same time by the UE 200.

In this case, the UE 200 may assume that only one DCI is detected at the same time (either single-CC scheduling or multi-CC scheduling).

Further, the UE 200 may assume that two DCIs, one for single-CC scheduling and the other for multi-CC scheduling, can be detected at the same time.

Further, in Option 1 or Option 2, the UE 200 may operate in any of the following manners upon receipt of a PDSCH.
Assume that only one PDSCH is detected at the same time (either single-CC scheduling or multi-CC scheduling)
Assume that two PDSCHs, one for single-CC scheduling and the other for multi-CC scheduling, can be detected at the same time.

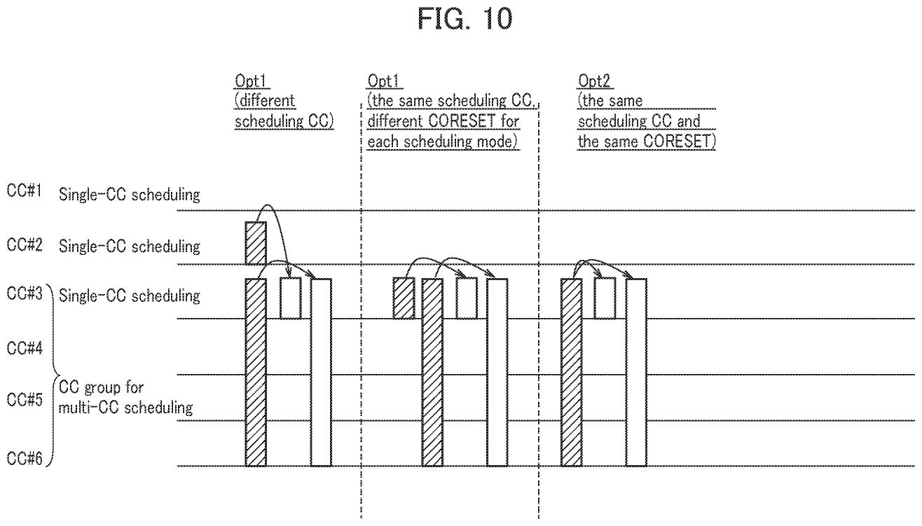

FIG. 10 illustrates a configuration example (No. 2) of a plurality of CCs and a CORESET (including a PDSCH) according to the second operation example. As in the configuration example (No. 1) illustrated in FIG. 9, both single-CC scheduling and multi-CC scheduling are applied to CC#3.

As in Option 1, a Scheduling CC for each scheduling mode may be configured. Further, in Option 1, the Scheduling CC is common to both the scheduling modes, but the CORESET configuration may be different between the scheduling modes.

Alternatively, as in Option 2, the Scheduling CC common to both the scheduling modes (and a shared CORESET configuration) may be configured.

### (4) Action and Effect

According to the above-described embodiment, the following action and effect can be obtained. Specifically, the UE200 can select, from among received RRC sets (the first control information and the second control information), an RRC set, that is, either the first control information or the second control information, to control a plurality of CCs on the basis of the RRC set thus selected.

Therefore, even when normal control information for a specific CC (RRC set), and, as in cross carrier scheduling, control information for a plurality of CCs across cells coexist, the UE200 can avoid a situation where it is not possible to appropriately determine which control information should be applied to a CC. That is, the UE 200 can suitably operate even in a case of, for example, cross carrier scheduling where a plurality of CCs across cells are controlled.

According to the present embodiment, when selecting an RRC set (the first control information) intended for a group including a plurality of CCs, the UE 200 may configure an HARQentity to be associated with the group (sub-group) of the plurality of CCs. Alternatively, the UE 200 may set an HARQ entity to be associated with the group including the plurality of CCs and an HARQentity to be associated with a CC belonging to the group.

This allows, even when the control is executed over the group of the plurality of CCs, efficient error correction and retransmission control.

According to the present embodiment, the UE 200 can schedule another component carrier belonging to the group on the basis of a reference CC. This makes it possible to reduce a processing load, due to the control over the plurality of CCs, on the UE 200.

According to the present embodiment, the UE 200 may assume that information on a bandwidth part (BWP) and information on a transmission configuration indication (TCI) are commonly applied to the group and each CC belonging to the group. Therefore, even when both the scheduling modes of single-CC scheduling and multi-CC scheduling are applied, it is possible to easily maintain the radio communication quality for a CC related to both the scheduling modes.

### (5) Other Embodiments

Although the above description has been given of the embodiment, the present disclosure is not limited to the description of the embodiment, and it is obvious to those skilled in the art that various modifications and improvements may be made.

For example, according to the above-described embodiment, the use of a high frequency band such as FR2x is a precondition, but at least one of the operation examples described above may be applied to a different frequency range, for example, a frequency band between FR1 and FR2.

Furthermore, FR2x may be divided into a frequency range of 70 GHz or lower and a frequency range of 70 GHz or higher, and any of the operation examples described above may be partially applied to the frequency range of 70 GHz or higher and the frequency range of 70 GHz or lower.

Moreover, the block diagram used for explaining the embodiments (FIG. 4) illustrates blocks of functional unit. Those functional blocks (components) can be realized by a desired combination of at least one of hardware and software. A method for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that causes transmitting may be called a transmitting unit or a transmitter. For any of the above, as explained above, the realization method is not particularly limited to any one method.

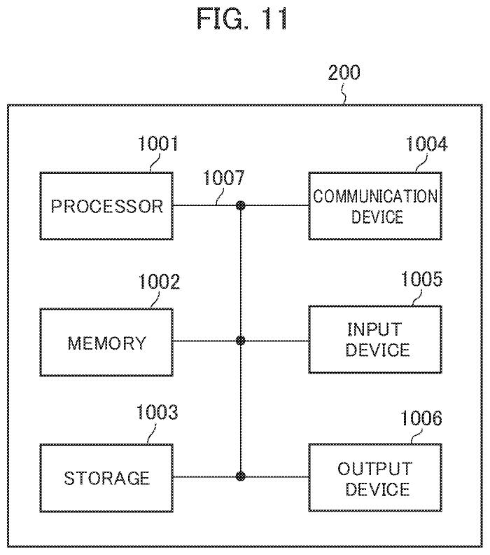

Furthermore, the UE 200 explained above can function as a computer that performs the processing of the radio communication method of the present disclosure. FIG. 11 is a diagram illustrating an example of a hardware configuration of the UE 200. As illustrated in FIG. 11, the UE 200 can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices illustrated in the figure, or can be constituted by without including a part of the devices.

The functional blocks (see FIG. 4) of the UE 200 can be realized by any of hardware elements of the computer device or a desired combination of the hardware elements.

Moreover, the processor 1001 performs computing by loading a predetermined software (program) on hardware such as the processor 1001 and the memory 1002, and realizes various functions of the UE 200 by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a program (program code), a software module, data, and the like from the storage 1003 and/or the communication device 1004 into the memory 1002, and executes various processes according to the data. As the program, a program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main storage device), and the like. The memory 1002 can store therein a program (program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information thereamong. The bus 1007 can be constituted by a single bus or can be constituted by separate buses between the devices.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), higher layer signaling (for example, RRC signaling, Medium Access Control (MAC) signaling, broadcast information (Master Information Block (MIB), System Information Block (SIB)), other signals, or a combination of these. The RRC signaling may be called RRC message, for example, or can be RRC Connection Setup message, RRC Connection Reconfiguration message, or the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, optical fiber cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station.

A radio frame may include one or a plurality of frames in the time domain. One or each of the plurality of frames in the time domain may be referred to as a subframe. Further, the subframe may include one or a plurality of slots in the time domain. The subframe may have a fixed time duration (for example, 1 ms) that does not depend on numerology.

The numerology may be a communication parameter applied to at least one of transmission or reception of a signal or channel. The numerology may indicate, for example, at least one of sub-carrier spacing (SCS), a bandwidth, a symbol length, a cyclic prefix length, Transmission Time Interval (TTI), the number of symbols per TTI, a radio frame structure, a specific filtering process to be performed by a transceiver in the frequency domain, a specific windowing process to be performed by the transceiver in the time domain, or the like.

A slot may include one or a plurality of symbols (Orthogonal Frequency Division Multiplexing (OFDM) symbols, Single Carrier Frequency Division Multiple Access (SC-FDMA) symbols, and the like) in the time domain. The slot may be a time unit based on numerology.

The slot may include a number of minislots. Each minislot may include one or a plurality of symbols in the time domain. Further, the minislot may also be referred to as a subslot. The minislot may be fewer than the slot in the number of symbols. A PDSCH (or PUSCH) transmitted in a time unit larger than the minislot may be referred to as PDSCH (or PUSCH) mapping type A. A PDSCH (or PUSCH) transmitted using the minislot may be referred to as PDSCH (or PUSCH) mapping type B.

The radio frame, subframe, slot, minislot, and symbol all represent a time unit for transmitting a signal. The radio frame, subframe, slot, minislot, and symbol may each have a different name.

For example, one subframe may be referred to as a transmission time interval (TTI), a plurality of contiguous subframes may be referred to as a TTI, and one slot or one minislot may be referred to as a TTI. That is, at least one of the subframe or TTI may be a subframe in existing LTE (1 ms), may have a duration shorter than 1 ms (for example, 1-13 symbols), or may have a duration longer than 1 ms. Note that the unit representing a TTI may be referred to as a slot, a minislot, or the like rather than a subframe.

Here, a TTI refers to, for example, the minimum time unit of scheduling in radio communication. For example, in the LTE system, a base station performs scheduling to allocate radio resources (frequency bandwidth that can be used by each user terminal, transmission power, and the like) to each user terminal in units of TTI. Note that the definition of TTI is not limited to this.

A TTI may be a transmission time unit of a channel-coded data packet (transport block), a code block, a codeword, or the like, or a processing unit such as scheduling or link adaptation. Note that when a TTI is given, a time slot (for example, the number of symbols) to which a transport block, a code block, a codeword, and the like are actually mapped may be shorter than the TTI.

When one slot or one minislot is referred to as a TTI, at least one TTI (that is, at least one slot or at least one minislot) may be the minimum time unit of scheduling. Further, the number of slots (the number of minislots) corresponding to the minimum time unit of scheduling may be controlled.

A TTI having a time duration of 1 ms may be referred to as a normal TTI (TTI in LTE Rel. 8-12), a normal TTI, a long TTI, a normal subframe, a normal subframe, a long subframe, a slot, or the like. A TTI shorter than the normal TTI may be referred to as a shortened TTI, a short TTI, a partial TTI or fractional TTI, a shortened subframe, a short subframe, a minislot, a subslot, a slot, or the like.

Note that the long TTI (for example, the normal TTI, the subframe, or the like) may also be read as a TTI that is longer than 1 ms in time duration, and the short TTI (for example, the shortened TTI or the like) may also read as a TTI that is shorter than the long TTI and equal to or longer than 1 ms in TTI duration.

A resource block (RB) is a resource allocation unit in the time domain and the frequency domain, and may include one or a plurality of contiguous subcarriers in the frequency domain. The number of subcarriers included in the RB may be constant regardless of numerology, and may be 12, for example. The number of subcarriers included in the RB may be determined on the basis of numerology.

Further, the RB in the time domain may include one or a plurality of symbols and may have a duration equivalent to one slot, one minislot, one subframe, or one TTI. One TTI, one subframe, or the like may include one or a plurality of resource blocks.

Note that one or a plurality of RBs may be referred to as a Physical Resource Block (Physical RB: PRB), a Sub-Carrier Group (SCG), a Resource Element Group (REG), a PRB pair, an RB pair, or the like.

Further, the resource block may include one or a plurality of resource elements (Resource Element: RE). For example, one RE may be a radio resource area of one subcarrier and one symbol.

A Bandwidth Part (BWP) (may also be referred to as a partial bandwidth) may represent a subset of contiguous common resource blocks (RBs) for a certain numerology on a certain carrier. Here, the common RBs may be specified by an RB index based on a common reference point of the carrier. A PRB may be defined in a certain BWP and numbered within the BWP.

The BWP may include a BWP for UL (UL BWP) and a BWP for DL (DL BWP). For a UE, one or a plurality of BWPs may be configured in one carrier.

At least one of the configured BWPs may be active, and the UE need not assume transmission or reception of any given signal/channel outside the active BWP. Note that a “cell”, a “carrier”, and the like according to the present disclosure may be read as a “BWP”.

The structures of the radio frame, subframe, slot, minislot, symbol, and the like described above are merely examples. For example, the number of subframes included in the radio frame, the number of slots per subframe or radio frame, the number of minislots included in the slot, the number of symbols and RBs included in the slot or minislot, and the number of subcarriers included in the RB, the number of symbols in the TTI, the symbol length, the Cyclic Prefix (CP) length, and the like may be variously changed.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the radio frequency domain, the microwave domain and light (both visible and invisible) domains, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each of the devices may be replaced with “unit”, “circuit”, “device”, or the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as “a”, “an”, and “the” in English are added, in this disclosure, these articles shall include plurality of nouns following these articles.

The term “determining” as used in this disclosure may encompass a wide variety of operations. “Determining” may be considered to be, for example, judging, calculating, computing, processing, deriving, investigating, searching (looking up, search, inquiry) (for example, searching for a table, a database, or another data structure), ascertaining, and the like. Further, “determining” may be considered to be receiving (for example, receiving information), transmitting (for example, transmitting information), inputting (input), outputting (output), accessing (for example, accessing data in a memory), and the like. Further, “determining” may be considered to be resolving, selecting, choosing, establishing, comparing, and the like. That is, the “determining” may be considered to be some operation. Further, “determining” may also be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 radio communication system
20 NG-RAN
100A, 100B gNB
UE 200
210 radio signal transceiver
220 amplifier
230 modulator/demodulator
240 control signal and reference signal processor
250 encoder/decoder
260 data transceiver
270 controller
BM beam
1001 processor
1002 memory
1003 storage
1004 communication device
1005 input device
1006 output device
1007 bus

1. A terminal comprising:
a receiver that receives, from a network, first control information and second control information, the first control information being intended for a group including a plurality of component carriers, the second control information being intended for each of the plurality of component carriers; and
a controller that selects either the first control information or the second control information and controls the plurality of component carriers on a basis of the first control information or the second control information selected.

2. The terminal according to claim 1, wherein the controller configures, when selecting the first control information, an automatic repeat request entity to be associated with the group including the plurality of component carriers.

3. The terminal according to claim 1, wherein the controller schedules, with cross carrier scheduling applied, another component carrier on a basis of a reference component carrier belonging to the group.

4. A terminal comprising
a controller that configures an automatic repeat request entity, wherein
the controller configures the entity to be associated with a group including a plurality of component carriers and the entity to be associated with a component carrier belonging to the group.

5. The terminal according to claim 4, wherein the controller assumes that information on a bandwidth part and information on a transmission configuration indication are commonly applied to the group and each of the component carriers.
